(19) United States
(12) Patent Application Publication
(10) Pub. No.: US 2010/0042521 A1
(43) Pub. Date: Feb. 18, 2010

(54) INVESTMENT AND DISTRIBUTION TO MINIMIZE TAX LIABILITY

(76) Inventor: Edward Dressel, Dallas, OR (US)

Correspondence Address: KOLISCH HARTWELL, P.C., 200 PACIFIC BUILDING, 520 SW YAMHILL STREET, PORTLAND, OR, 97204, US

(21) Appl. No.: 12/190,504

(22) Filed: Aug. 12, 2008

(51) Int. Cl. G06Q 40/00

(52) U.S. Cl. 705/31

(57) ABSTRACT

Methods, instructions on computer media and computing devices are provided for distribution from and investment into a plurality of accounts. In particular, the methods, instructions and computing devices provide for the minimization of tax liability during distribution and investment. An investor may invest funds into and receive distributions from a plurality of accounts based on some combination of tax obligations associated with each account and effective tax rates applicable to various portions of the investor's income. Maximum effective tax rates at present and at some point in the future, such as after retirement, may also be utilized for strategic investment.

### BACKGROUND OF THE DISCLOSURE

An investor may invest funds in various types of accounts, and funds may then be distributed from the accounts to a recipient as income, for example, during periods of unemployment, particularly during retirement. Many types of specialized retirement accounts have been created for this purpose.

Tax-deferred retirement accounts contain money that was not taxed prior to investment, but distributions from this type of retirement account may be taxed. An example of a tax-deferred account is a retirement account provided by 26 U.S.C. §401(k) (“401(k) account”). Other retirement accounts contain money that was taxed prior to investment. In these retirement accounts, distributions are often not taxed. An example of such an account is a Roth Individual Retirement Account (“Roth IRA”).

For a variety of reasons, it is common for investors to invest funds into more than one, or even several, different types of accounts, over a period of the investor's life, such as during employment. Funds from such sources may be distributed to a recipient first from Roth IRAs and then from other sources such as tax-deferred retirement accounts. The reason for this is that funds in tax-deferred accounts are thought to grow more quickly, and thus, should be allowed to grow as long as possible.

### SUMMARY

In a first aspect of this disclosure, methods and instructions on storage media and computing devices are provided for minimizing the tax liability over a period of multiple income distributions for a recipient that receives income distributions from a plurality of sources, by selectively distributing funds based on the recipient's effective tax bracket and the tax obligation associated with each of the plurality of sources wherein each source has an associated tax obligation. In a second aspect, an investor's tax liability can be minimized by selecting funds in which to invest, based upon the investor's maximum effective tax rate at present and a recipient's maximum effective tax rate at some point in the future.

In the first aspect, funds may be distributed from a plurality of sources to a recipient, each source having an associated tax obligation, by selecting a first state income tax rate for the recipient, the first state income tax rate having a first income floor and a first income ceiling; selecting a first federal income tax rate for the recipient, the first federal income tax rate having a second income floor less than the first income ceiling and a second income ceiling greater than the first income floor; determining a first effective tax rate for the recipient based at least partially on both the first state income tax rate and the first federal income tax rate; selecting from the plurality of sources a first source with an associated first tax obligation that is greater than a second tax obligation associated with a second source; distributing funds to the recipient from the selected first source at the lesser of the first effective tax rate and the first tax obligation until the lesser of the first income ceiling and the second income ceiling is reached; and thereafter distributing funds to the recipient from the second source at the lesser of a second effective tax rate and the second obligation.

In the second aspect, funds may be invested by an investor into a plurality of accounts by determining a first tax rate comprising a maximum effective tax rate applicable to the investor at a present time; determining a second tax rate comprising a maximum effective tax rate applicable to a recipient of the funds at a predetermined future time; selecting from the plurality of accounts a first account with an associated first tax obligation; selecting from the plurality of accounts a second account with an associated second tax obligation that is lower than the first tax obligation; and investing the funds into either the first account if the first tax rate is greater than the second tax rate or the second account if the second tax rate is greater than the first tax rate.

### DESCRIPTION OF THE DRAWINGS

FIG. 1 is a chart showing examples of state and federal income tax rates for various income ranges, as well as the effective tax rates that result from the combination of state and federal taxes at the various income ranges.

FIG. 2 is a flowchart showing an example of a method of distributing funds from a plurality of sources.

FIG. 3 is flowchart showing an example of a method of determining an effective tax rate.

FIGS. 4 and 5 depict distributions of funds from a plurality of sources using traditional models and disclosed methods, respectively.

FIGS. 6 and 7 are bar charts illustrating distributions of funds from a plurality of sources using traditional models and disclosed methods, respectively.

FIG. 8 shows an example graphical user interface (“GUI”) for viewing results of a traditional retirement distribution method compared to the results of a retirement distribution method as disclosed herein.

FIG. 9 shows an example GUI for setting distribution priorities.

FIG. 10 is a flowchart showing an example of a method of investing funds into a plurality of accounts strategically based upon future distributions from the plurality of accounts.

### DETAILED DESCRIPTION

In one aspect, methods, instructions on storage media and computing devices are provided for the distribution of funds from a plurality of sources. In many cases, and as described in the examples discussed herein, the distributions occur during an individual's retirement, although this is not required; distributions may take place over any period, or periods, of an individual's lifetime, in which multiple income distributions occur. In another aspect, methods and instructions on storage media and computing devices are provided for investment of funds into a plurality of accounts based on future distributions. A goal in both aspects is to strategically minimize total tax liability over a period of time that includes multiple income distributions, such as during retirement, using two factors: one or more tax rates applicable to the individual; and a tax obligation associated with each source. In some cases, such methods may also maximize the yield and/or duration of distribution from the plurality of sources.

For the purposes of this disclosure, the term “investor” refers to an entity that places funds into one or more accounts for distribution at a later date, and the term “recipient” refers to an entity that receives funds distributed from one or more sources. Sources may include accounts into which an investor invests funds, as well as other sources of funds, such as Social Security, which may comprise income. Thus, although the specific illustrative examples herein demonstrate the application of the disclosed methods in scenarios in which a single individual is both the investor and the recipient, thus is not required in all embodiments. For example, the investor may be any taxable entity such as a corporation or a partnership, a married couple, and so forth, and the recipient may be the same taxable entity, or a different taxable entity than the investor. Such variations are considered to be within the scope of the disclosure. In a common but non-limiting scenario, several examples of which are discussed herein, an individual acts as an investor during her years of employment, investing in one or more accounts such as a 401(k), and as a recipient during her years of retirement, receiving as income funds distributed from her accounts.

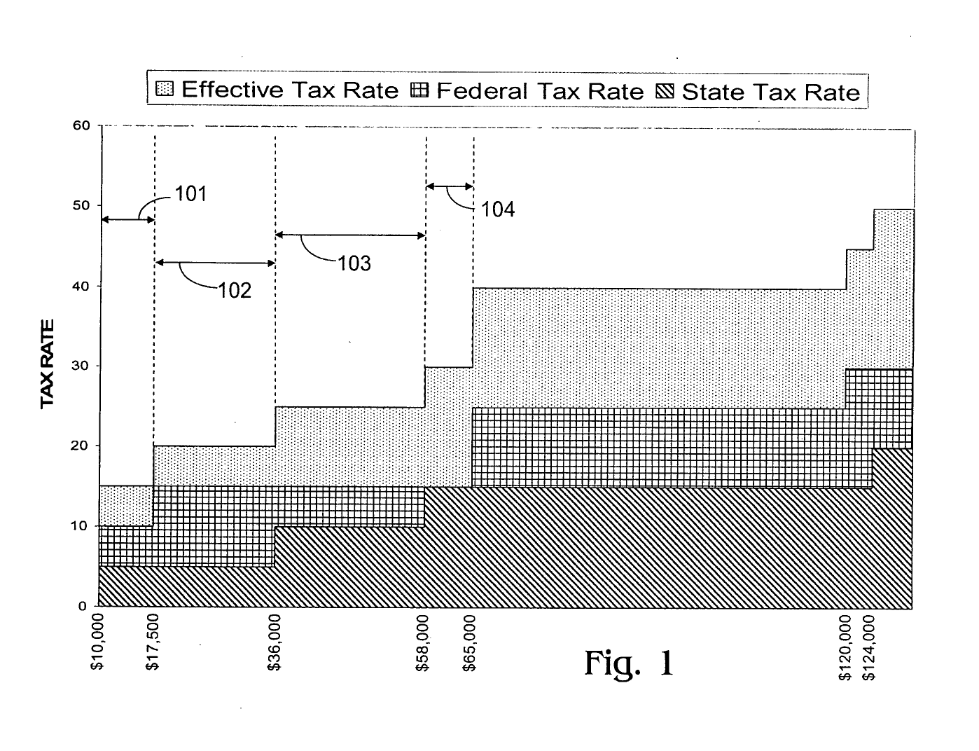

Various portions of a recipient's income may be subject to income tax liability at varying tax rates. State, federal and/or other types of income taxes may have multiple tax rates, which are sometimes referred to as marginal tax brackets or rates. In a marginal tax bracket model, income earned between a minimum income level (referred to herein as an “income floor”) and a maximum income level (referred to herein as an “income ceiling”) may be taxed at a first income tax rate, and income earned above the first income ceiling may be taxed at a second, usually higher income tax rate (for which the first income ceiling is the income floor). This is illustrated in FIG. 1, where the horizontal axis represents levels of income, and the vertical axis represents applicable tax rates. The specific numbers used in FIG. 1 are for illustrative purposes only, and are not meant to be limiting in any way.

In the example of FIG. 1, state income tax rates are the lowest. Incomes from $10,000 to an income ceiling of about $36,000 are taxed at a 5% state income tax rate. Incomes from an income floor of about $36,000 to an income ceiling of about $58,000 are taxed at a state income tax rate of 10%. Incomes from an income floor of about $58,000 to an income ceiling of about $124,000 are taxed at a state income tax rate of 15%. Incomes beyond an income floor of about $124,000 are taxed at a state income tax rate of 20%.

The example federal income tax rates in FIG. 1 are somewhat higher than the example state income tax rates. Incomes from an income floor of $10,000 to an income ceiling of about $17,500 are taxed at a 10% federal income tax rate. Incomes from an income floor of about $17,500 to an income ceiling of about $65,000 are taxed at a 15% federal income tax rate. Incomes from an income floor of about $65,000 to an income ceiling of about $120,000 are taxed at a federal income tax rate of 25%. Incomes beyond an income floor of about $120,000 are taxed at a federal income tax rate of 30%. While not shown in FIG. 1, other income taxes, such as county and municipal income taxes, also may be applicable.

An effective tax rate, as the term is used herein, refers to the total rate at which a portion of a recipient's income is taxed after all applicable income taxes have been applied. Thus, in states that impose state income taxes on eligible recipients, the effective tax rate usually includes at least an applicable state income tax rate and an applicable federal income tax rate. In some cases, the effective tax rate is simply the sum of the applicable state and federal income tax rates. Some states do not impose income taxes, and therefore, an effective tax rate applicable to a citizen of such a state may include only a federal income tax rate. An effective tax rate may additionally or alternatively be based upon, or otherwise relate to, other types of applicable income taxes, such as municipal tax, city tax, county tax, and the like.

Effective tax rates are shown in FIG. 1 as the sum of state and federal income tax rates. For example, at the income range indicated at 101, the applicable state tax rate is 5%, and the applicable federal tax rate is 10%, combining for an effective tax rate of 15%. At the income range indicated at 102, the applicable state tax rate is 5%, and the applicable federal tax rate is 15%, combining for an effective tax rate of 20%. At the income range indicated at 103, the applicable state tax rate is 10%, and the applicable federal tax rate is 15%, combining for an effective tax rate of 25%. At the income range indicated at 104, the applicable state and federal tax rates are both 15%, combining for an effective tax rate of 30%. This pattern continues as income continues to increase.

A tax obligation, as the term is used herein, refers to a rate at which funds distributed from a particular source are taxed, and is specific to the source, or to the type of source. Some sources have tax obligations that are set by applicable laws or regulations, regardless of applicable effective tax rates. For example, capital gains from investments (e.g., stocks, mutual funds) are currently taxed at a flat, federal tax rate of 15%, regardless of any applicable effective tax rate. Some sources have tax obligations equal to zero. For example, retirement distributions from a Roth IRA are not taxed. Other sources have associated tax obligations that are dependent upon other, external factors. For example, funds distributed from a 401(k) retirement account are taxed at the applicable effective tax rate; in other words, a 401(k) account has an associated tax obligation that is equal to the applicable effective income tax rate.

Distribution of Funds from a Plurality of Sources

Funds may be distributed strategically from a plurality of sources to a recipient in such a way as to minimize the recipient's tax liability over a time period that includes multiple income distributions, such as during retirement. This strategic distribution also may maximize the yield of distribution and/or the length of time the sources contain funds from which to distribute.

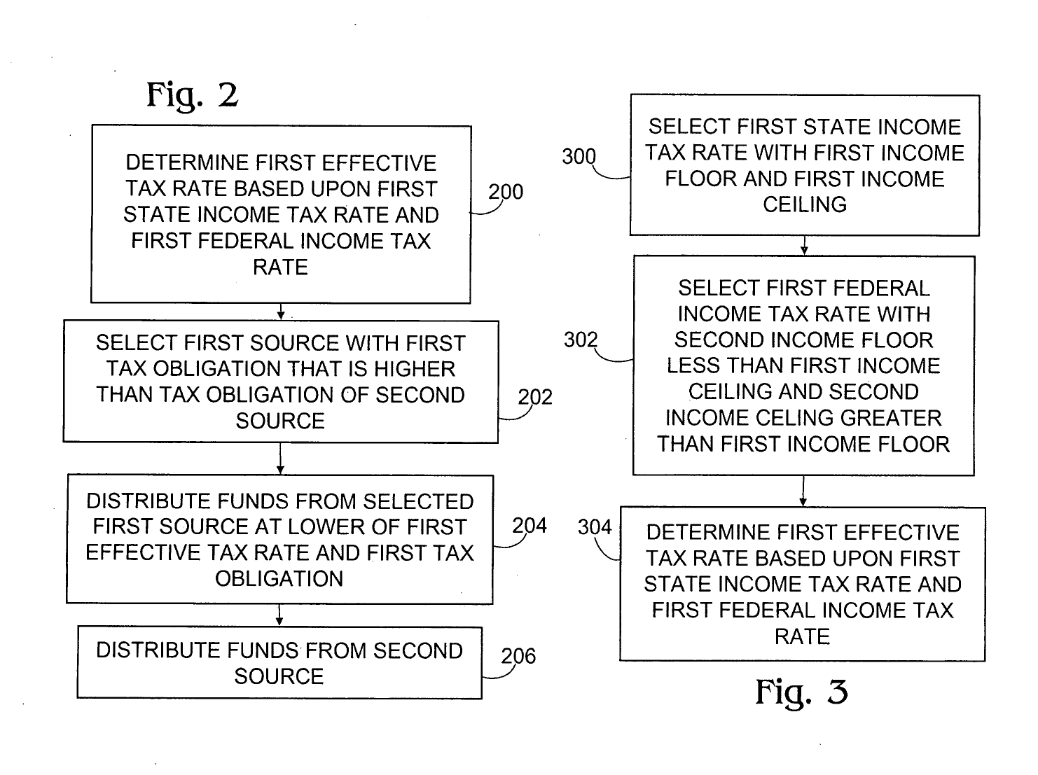

FIG. 2 depicts an example of a method of distributing funds from a plurality of sources, at least some of which have different associated tax obligations. In step 200, a first effective tax rate for the recipient is determined. As mentioned above, the first effective tax rate may be based upon various state, federal and other income tax rates, and for example, as discussed in detail below, may be the sum of all of all applicable federal, state, and local income tax rates. In many embodiments, the first effective tax rate will be less than effective tax rates applicable to later income ranges.

FIG. 3 depicts an example of a method of determining the first effective tax rate. In step 300, a first state income tax rate with a first income floor and a first income ceiling is selected. In some embodiments, the first state income tax rate selected is the state income tax rate applicable to the lowest income level. In step 302, a first federal income tax rate with a second income floor less than the first income ceiling and a second income ceiling greater than the first income floor is selected. In other words, the first federal income tax rate is applicable to an income range that at least partially overlaps the income range to which the first state income tax is applicable. The income range indicated at 102 in FIG. 1 is an example of this.

In step 304, a first effective tax rate is determined based at least partially on both the first state income tax and the first federal income tax rate. In some embodiments, the first effective tax rate is the sum of the first state income tax rate and the first federal income tax rate. As noted above, the first effective tax rate may further comprise other applicable tax rates, including county and municipal taxes.

Once the first effective tax rate is determined, funds may be distributed to the recipient. Referring back to FIG. 2, in step 202, a first source is selected from a plurality of sources, the first source having an associated first tax obligation that is higher than a second tax obligation associated with a second source. In some embodiments, the first source that is selected is the source having the highest tax obligation of any of the plurality of sources. For example, the first source may be a tax-deferred retirement account such as a 401(k), a 403(b), a 457(b), a 457(f) or a Traditional Individual Retirement Account, and so forth, all of which have tax obligations equal to the applicable effective tax rate.

In step 204, funds are distributed from the selected first source at the lower of the first effective tax rate and the first tax obligation. Where the first source is one of the tax-deferred accounts discussed above, the first effective tax rate is equal to the first tax obligation, and therefore, funds are distributed at either rate. However, if the first tax obligation is lower than the first effective tax rate, as is the case with later income ranges discussed below, then funds would be distributed at the tax rate determined by the first tax obligation. In some embodiments comprising instructions on storage media, the instructions may be executed by a processor to determine the distribution scheme discussed above, which may then be communicated to a user, such as via a printer or display monitor.

Distribution of funds from a source (such as the first source) may continue until a distribution-terminating event occurs. One example of a distribution-terminating event is when the amount of funds distributed reaches a predetermined income limit. Such an income limit may correspond to the amount of income that has been determined to be sufficient to maintain a recipient's needs or lifestyle (e.g., maintaining an individual's desired standard of living), or any desired income limit. In this example, once the income limit is reached, distribution from the source terminates, and no distributions are made from other sources thereafter, until the next distribution period. For example, if distributions are made on an annual basis, if the annual income limit is reached by distributing funds from the first source, no more funds are distributed from any source until the following annual distribution.

Another example of a distribution-terminating event is when funds in a particular source are depleted. When this occurs, if the desired income for the distribution period is not yet reached, funds may then be distributed from another source. This other source may be selected from the plurality of sources in the same manner that another source is chosen after a transition from one effective tax rate to another. If there are no more funds in any other sources, further distributions may be limited to distributions from non-investment sources, income from Social Security, and so forth.

A third example of a distribution-terminating event is the transition from one effective tax rate to another. For example, in FIG. 3, the first effective tax rate is based on both the first state income tax rate (with a first income ceiling) and the first federal income tax rate (with a second income ceiling). In such a scenario, funds may be distributed from the first source until an income ceiling (such as the lesser of the first income ceiling and the second income ceiling) is reached.

The foregoing examples of distribution-terminating events are merely examples, and are not meant to be limiting in any way. Any event that causes distribution from a source to terminate is considered to be within the scope of the present disclosure.

Referring back to the process shown in FIG. 2, and assuming the distribution-terminating event was reaching an income ceiling, in step 206, funds may be distributed from the second source at the lower of a second effective tax rate and the second tax obligation. It should be understood that distribution from the second source is not required in all embodiments. For instance, if the second effective tax rate is only slightly higher than the first effective tax rate, the recipient may await a more significant difference between effective tax rates before she stops withdrawing from the first source and begins withdrawing from the second source. As another example, if the first distribution-terminating event is reaching a predetermined income limit, distributions from other sources, such as the second source, are not needed.

The second effective tax rate (and any other effective tax rate thereafter) may be determined in a similar manner as the first effective tax rate. Continuing with the example described in FIG. 3, if the first income ceiling associated with the first state income tax rate is higher than the second income ceiling associated with the first federal income tax rate, then the second effective tax rate, in this example, will be the sum of the first state income tax rate and a second federal income tax rate having a third income floor less than the first income ceiling. In contrast, if the first income ceiling associated with the first state income tax rate is lower than the second income ceiling associated with the first federal income tax rate, then the second effective tax rate will be the sum of a second state income tax rate having a fourth income floor less than the second income ceiling and the first federal income tax rate.

In one common scenario, the second source may comprise capital gains from investments, making the second tax obligation equal to 15%. If the second effective tax rate is higher than 15%, as is the case in the income range indicated at 102 in FIG. 1, capital gains nonetheless are taxed at 15%.

Similar to distributions of funds from the first source, distribution of funds from the second source in step 206 may occur until a second distribution-terminating event is reached, for example, when either the lesser of the first income ceiling and a third income ceiling associated with the second federal income tax rate is reached, or the lesser of the second income ceiling and a fourth income ceiling associated with the second state income tax rate is reached.

Thereafter, if the-predetermined income limit is not yet reached, a third source may be selected from the plurality of sources for distribution. The third source may have an associated third tax obligation that is less than the second tax obligation associated with the second source. The third source may be distributed at the lesser of the third tax obligation and a third effective tax rate. The third effective tax rate may be determined in a similar manner as the first and second effective tax rates, and typically will be greater than those two rates (see, e.g., the income range indicated by numeral 103 in FIG. 1).

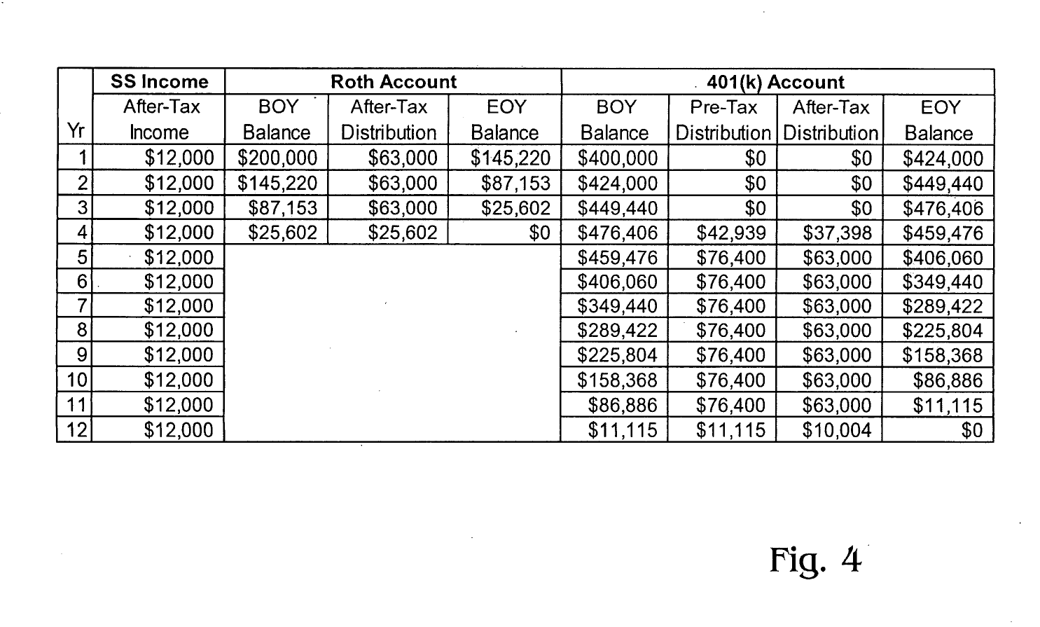

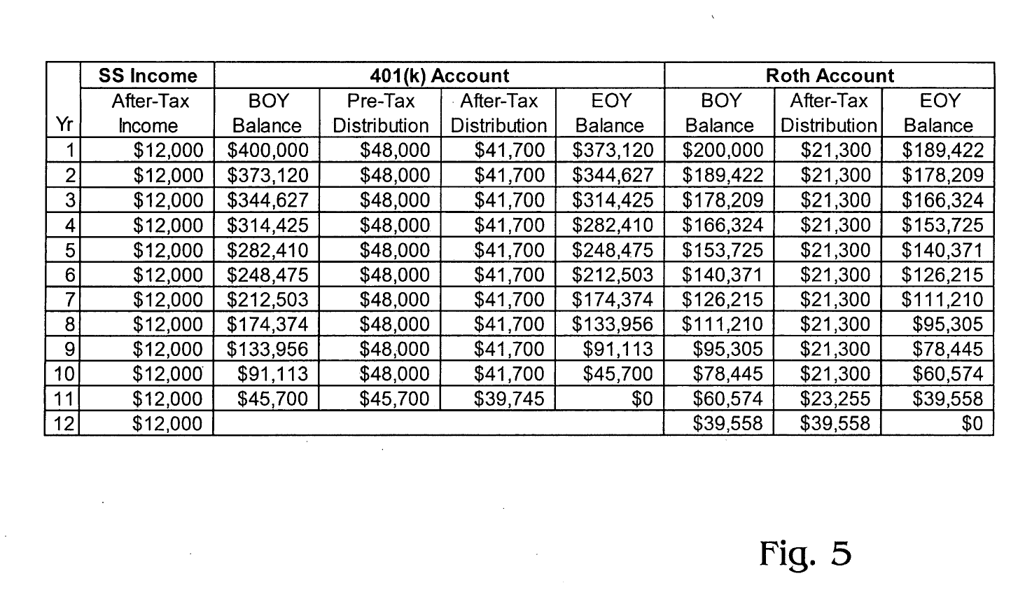

The tables in FIGS. 4 and 5 include example annual distributions from a plurality of sources over a representative period of 12 years, and compare the tax liability between a traditional distribution model that favors late distribution from tax-deferred accounts (in FIG. 4) and distribution according to the methods discussed herein (in FIG. 5). The scenario shown in both FIGS. 4 and 5 is an illustrative scenario for an individual investor with two retirement accounts: a Roth IRA with a balance of $200,000, and a 401(k) with a balance of $400,000, with each account earning 6% annually in interest and with annual distributions occurring at the beginning of each year. Additionally, in this scenario, the individual will receive income of $1,000 every month in Social Security benefits. As such, assuming a desired after-tax income is $75,000 per year, an additional $63,000 of after-tax income will need to be distributed each year from the other two accounts. Also, in this scenario, income earned below an income floor of $12,000 is not taxed; income from an income floor of $12,000 to an income ceiling of $30,000 is taxed at a 10% effective tax rate; income from an income floor of $30,000 to an income ceiling of $60,000 is taxed at a 15% effective tax rate; and income greater than an income floor of $60,000 is taxed at a 25% effective tax rate.

FIG. 4 depicts the results of distributing funds from these sources using traditional models, which, as mentioned previously, favor distribution from tax-deferred accounts as late as possible. As shown in the “After-Tax Distribution” column of the “Roth Account” section, the required $63,000 annual distribution is drawn entirely from the Roth IRA at first, and once that account is depleted, in year 4, funds are distributed from the 401(k). In the traditional model, effective tax rates are not considered; money is simply distributed from the Roth IRA until it is depleted, and then from the 401(k). Because income from the Roth is not taxed at distribution, the individual does not pay taxes on retirement distributions until year 4, which is when the individual begins receiving distributions from the 401(k). More specifically, in year 4, the remaining $25,602 in the Roth IRA is distributed, and the balance of the total required distribution of $63,000 is drawn from the individual's 401(k) account. However, because the 401(k) distributions are taxed at the individual's effective tax rate(s), $42,939 must be distributed for an after-tax distribution of $37,398. As such, the individual pays $5,541 in taxes on the 401(k) distribution in year 4. Each year thereafter, until the 401(k) is depleted in year 12, the individual pays $13,400 in taxes (in year 12, the individual pays $1,112 in taxes on the remaining balance). Thus, in the traditional model, the total amount of taxes paid after depletion of the 401(k) account is $100,453.

In FIG. 5, the funds are distributed strategically from the 401(k) and Roth IRA using methods described above to minimize tax liability. In particular, funds are distributed from the 401(k) throughout the lower two tax brackets (10% and 15%). Once the individual's income reaches the income ceiling of $60,000 ($12,000 in income from Social Security plus $48,000 in pre-tax income from the 401(k)), additional income would be within the income range in which the 25% effective tax rate would be applicable. As such, in this example, the transition to the 25% effective tax rate is the distribution-terminating step at which further distributions are made from a second source; in other words, when the income ceiling for the effective tax rate of 15% is reached, the individual then draws from the Roth IRA, which is not taxed. Consequently, the individual avoids the 25% effective tax rate altogether.

In the example of FIG. 5, in each of years 1-10, the individual pays $6,300 in taxes on the distributions from the two accounts, of which only one, the 401(k) account, has a non-zero tax obligation. In year 11, after drawing $39,745 in after tax income from the individual's 401(k) and paying $5,955 in taxes, the individual's 401(k) is depleted, and thereafter the individual withdraws funds entirely from the Roth IRA. Thus, using the distribution model disclosed herein, the total amount of taxes paid over 12 years of distributions is $68,955, compared to $100,453 using the traditional model. Accordingly, the use of disclosed methods, in this scenario, results in savings of $31,498.

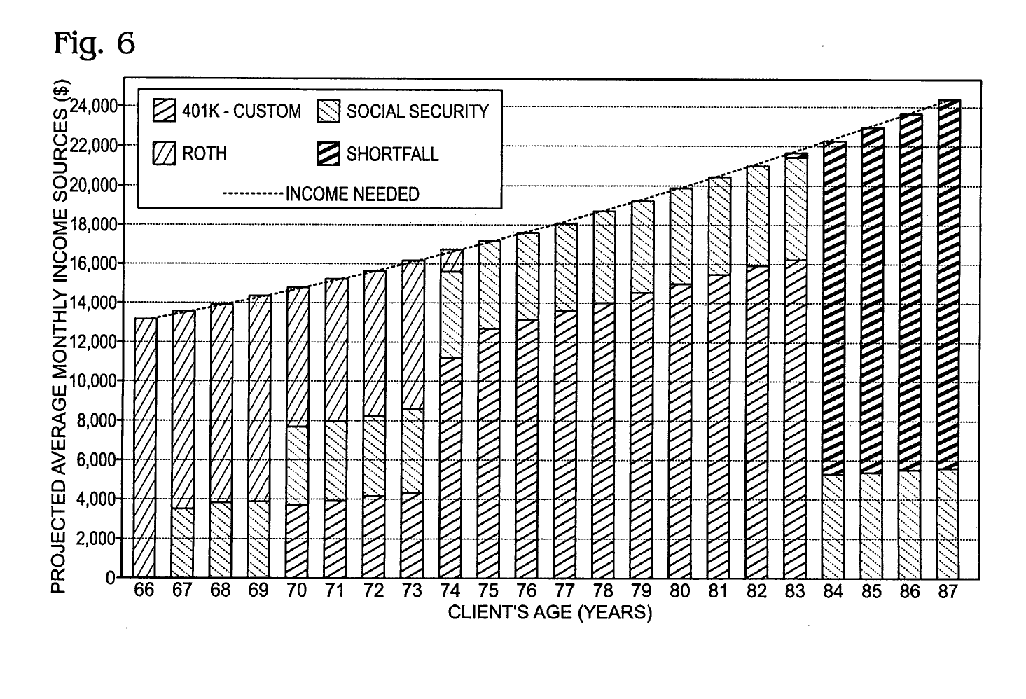

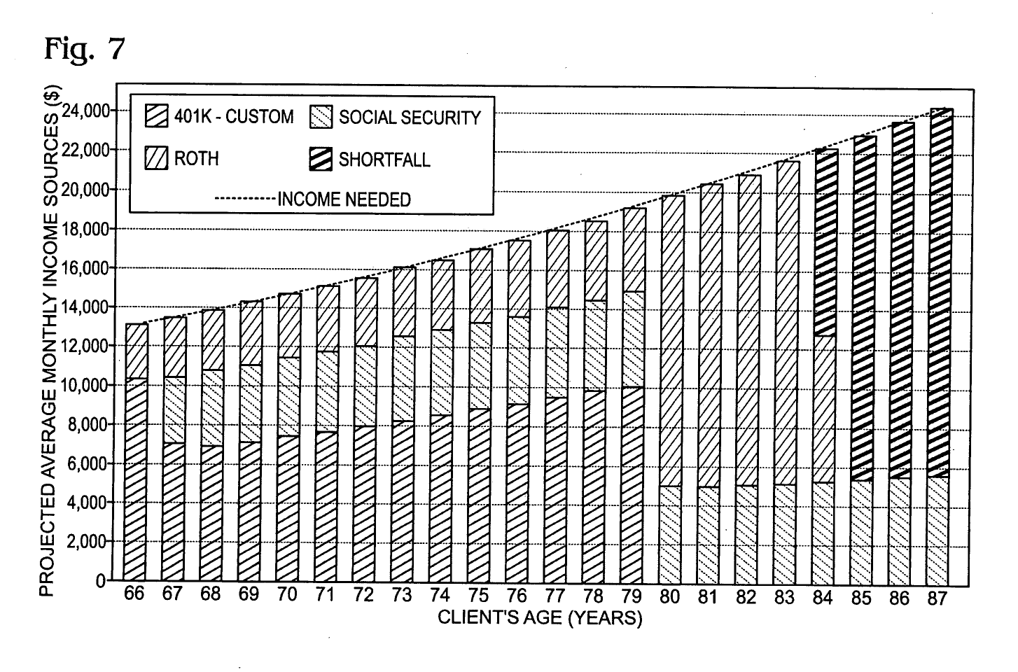

The charts in FIGS. 6 and 7 illustrate another example of the effect of practicing the foregoing methods during retirement, as compared with traditional retirement distribution methods. Each of these charts again assumes that a recipient receives retirement income from three sources: a 401(k) retirement account; Social Security; and a Roth IRA. They also assume that the recipient requires approximately $13,000 per month income, adjusted steadily upward to account for inflation and/or a rising cost of living.

FIG. 6 depicts the results of distributing funds from these three sources using traditional models. In the first year of retirement (age 66), all income is drawn from the Roth IRA. Distribution of Social Security benefits begins at age 67, and is fully taxed (i.e., has a tax obligation equal to the applicable effective tax rate). Accordingly, from age 67 on, the retiree may draw less from the Roth IRA.

At age 70½, the retiree is required to withdraw funds from the 401(k). Under traditional models, because tax-deferred accounts are the last sources from which funds are distributed, the retiree draws as little as possible from the 401(k) from ages 70 to 73, and instead continues to draw from the Roth IRA. However, at age 74, the Roth IRA begins to run out, and so the retiree must draw more from the 401(k) in order to maintain the same income level (which is now approximately $17,000 per month).

At age 75 and beyond, the Roth IRA is depleted, and so the retiree's income is distributed entirely from Social Security and the 401(k). In this example, the 401(k) begins to run out during the retiree's 83^{rd} year. After that, the retiree's income consists entirely of Social Security, and there is a monthly shortfall of over $15,000.

FIG. 7 depicts the results of distributing the same funds from the same three sources using the methods described above to minimize tax liability. It should be understood that the income ceiling between the first effective tax rate and the second effective tax rate, which is slightly greater than $10,000 in the 66^{th} year, increases steadily throughout the retiree's life in order to compensate for cost of living adjustments.

Using the foregoing methods, the source with the highest tax obligation (the 401(k)) is the first source from which funds are distributed to the retiree. Beyond the first income ceiling of just over $10,000, the retiree draws some funds from the Roth IRA in order to arrive at the total monthly income of about $13,000.

Once again, distribution of Social Security benefits begin at age 67. Accordingly, until the first income ceiling of just over $10,000 is reached, funds are distributed from the 401(k) and Social Security, both which have tax obligations equal to the applicable tax rate. Funds distributed beyond this income ceiling and at a second higher tax rate are distributed from the Roth IRA, which is not taxed.

This pattern continues until age 80, when the 401(k) is depleted. Beyond age 80, funds are distributed entirely from Social Security and the Roth IRA. At age 84, again there is an average monthly shortfall. However, the average monthly shortfall resulting from using the above-described methods, as shown in, FIG. 7, is less than $10,000. In contrast, the average monthly shortfall using traditional models, as shown in FIG. 6, is well over $15,000. As such, in this scenario, the disclosed methods result in decreased tax liability and increased duration of distributions from a plurality of sources.

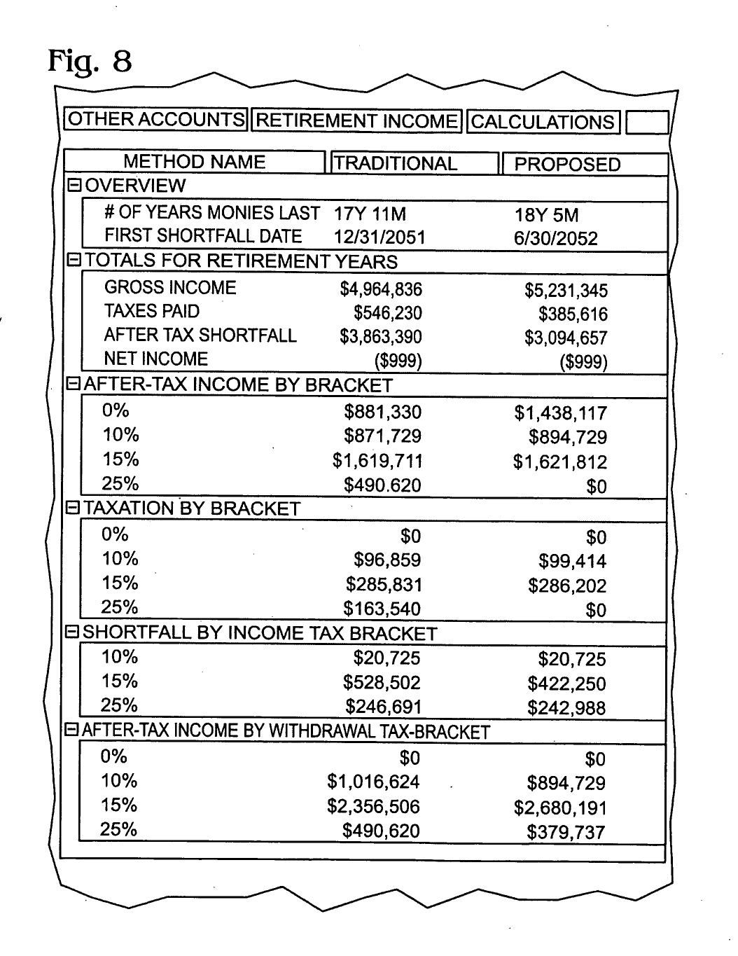

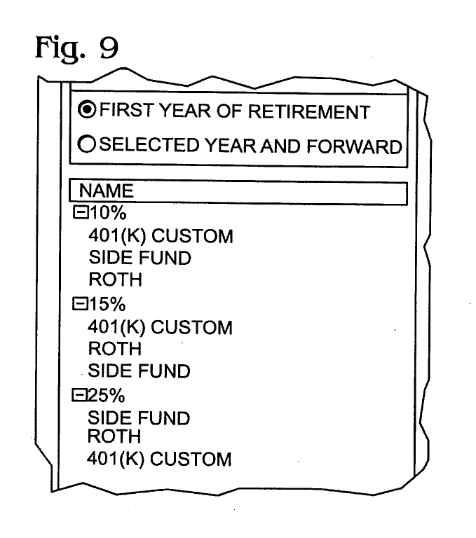

A GUI such as that generated by a software program that produces a distribution scheme according to the disclosed methods, is depicted in FIG. 8 and shows another set of sample results obtained using traditional distribution models versus methods described above. It can be seen that tax liability decreases using foregoing methods by comparing the “TAXES PAID” in the “TRADITIONAL” column with that in the “PROPOSED” column. More specifically, under the traditional distribution models, $546,230 is paid in taxes, but only $385,616 is paid in taxes under the foregoing methods. Additionally, funds run out after seventeen years and eleven months using the traditional distribution methods. In contrast, funds last eighteen years and five months using the methods described above.

FIG. 9 depicts another example GUI for manually configuring distribution priorities for a plurality of sources. This GUI may be used to configure distribution using traditional models or the foregoing methods. In this example, funds distributed at incomes taxed at an effective tax rate of 10% are drawn first from a 401(k), and if that runs out, a side fund, and if that runs out, a Roth IRA. Funds distributed at incomes taxed at an effective tax rate of 15% are drawn from the 401(k) first, then the Roth IRA, and then the side fund. Last, funds distributed at incomes taxed at an effective tax rate of 25% are drawn first from the side fund, and if that runs out, the Roth IRA, and if that runs out, the 401(k).

Investment of Funds into a Plurality of Accounts

An investor may invest funds in a plurality of accounts throughout her lifetime so that these funds may be distributed to the individual at a later time, such as during retirement. An account as referred to herein is synonymous to a source of funds for distribution discussed above. The terms “account” and “retirement account” are used in this section merely to clarify that funds are being invested into accounts at this time, and not distributed from them. Although the individual who Invests funds into the plurality of accounts and the individual who receives funds from the plurality of accounts are referred to as the “investor” and the “recipient,” respectively, it should be understood that these two individuals may be (and often will be) the same person.

An investor may invest funds in various accounts based upon future distribution strategy. In particular, an investor may compare her present maximum effective tax rate (MTR_{P}) to a recipient's maximum effective tax rate at a predetermined future time, such as retirement (MTR_{R}), and invest funds in various accounts based on the result of the comparison. The following example compares the ultimate distribution value of a deposit as invested in a tax-deferred account, such as a 401(k), versus an account with a tax obligation of zero, such as a Roth IRA. The example illustrates why maximum effective tax rates at present and in the future may be determinative of where the investor should invest her funds in order to minimize the investor's tax liability.

The pre-tax value of an investment into a tax-deferred account such as a 401(k) upon distribution may be represented by the following formula:

pre-tax distribution=pre-tax investment×(1+interest rate)^{N}

where N equals the number of years passed. Because distributions from such accounts are taxed, the actual amount received at retirement from that deposit is represented by the following formula:

post-tax distribution=pre-tax distribution×(1-MTR_{R})

Combining the two formulae results in the following:

post-tax distribution=pre-tax investment×(1+interest rate)^{N}×(1-MTR_{R})

Investments into accounts with tax obligations of zero, such as a Roth IRA account, contain money that has already been taxed. Accordingly, the value of the investment is represented by the following formula:

post-tax investment=pre-tax investment×(1-MTR_{P})

Distributions from such accounts are tax-free, or in other words, have a tax obligation of zero. Accordingly, the value of the post-tax deposit upon distribution is represented by the following formula:

post-tax distribution=post-tax investment×(1+interest rate)^{N}

Combining these two formulae results in:

post-tax distribution=pre-tax investment×(1-MTR_{P})×(1+interest rate)^{N}

The only difference between the post-tax distribution amounts between the tax-deferred source and the source with a tax obligation of zero is the maximum tax rate. If MTR_{P}=MTR_{R}, then there is no difference between investing in the two sources. However, if MTR_{P} is not equal to MTR_{R}, then the investor can selectively invest in one of the retirement accounts to minimize tax liability.

In particular, if MTR_{P} is greater than MTR_{R}, then investment in the tax-deferred account will decrease tax liability. This is because the higher MTR_{P} is avoided, and the money is distributed at retirement at the lower MTR_{R}.

On the other hand, if MTR_{P} is less than MTR_{R}, then investment in the account with an associated tax obligation of zero decreases tax liability. This is because prior to investment, the money is taxed at the lower MTR_{P}, and the higher MTR_{R} is avoided.

While the example above refers to specific accounts such as a 401(k) and Roth IRA, it should be understood that the comparison applies more broadly to other types of accounts. For example, assume that a first account has a tax obligation higher than that of a second account, but deposits into the first account are taxed at a reduced tax rate. If the difference between the reduced tax rate and the investor's present maximum effective tax rate is large enough, and the investor's present maximum effective tax rate is greater than her maximum effective tax rate during retirement, then investing in the first account may result in higher yield at distribution than investment into the second account.

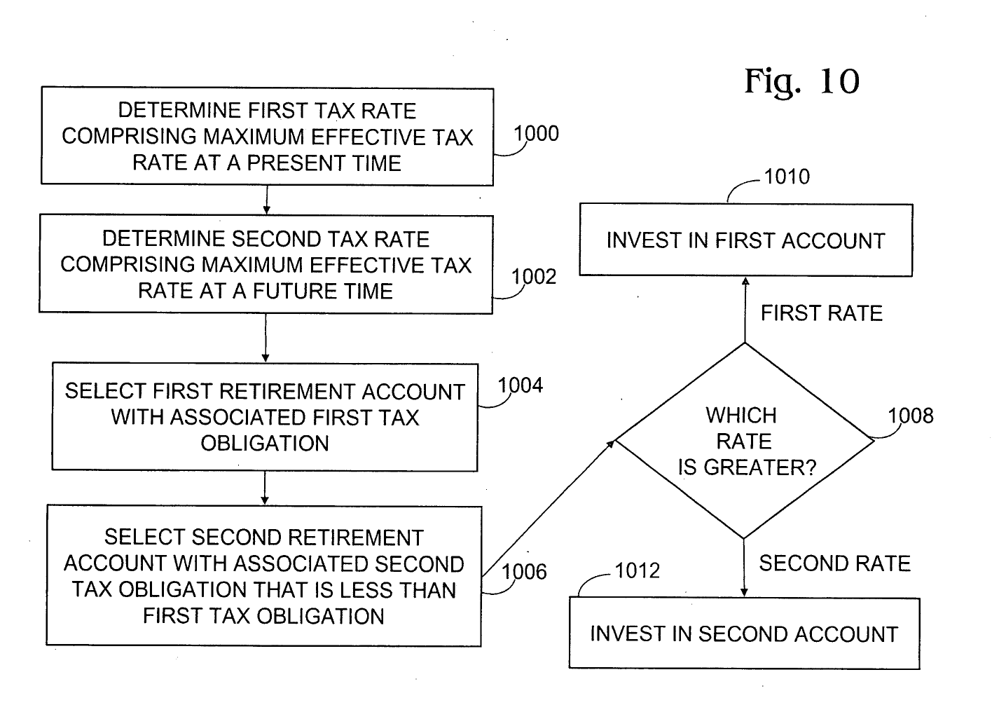

In light of the above, methods, instructions on storage media and computing devices are provided for investing funds into a plurality of accounts in a manner than minimizes tax liability in order to maximize yield and/or duration of distribution. FIG. 10 is a flowchart depicting one such example method.

In step 1000, a first tax rate comprising the maximum effective tax rate at a present time is determined. The maximum effective tax rate may be determined by selecting a maximum state income tax rate with a first income floor and a first income ceiling that is applicable to the investor at the present time; selecting a maximum federal income tax rate with a second income floor less than the first income ceiling and a second income ceiling greater than the first income floor that is applicable to the investor at the present time; and determining the maximum effective tax rate applicable to the investor at the present time based at least partially on both the maximum state income tax and the maximum federal income tax rate. In some embodiments, the first tax rate is the sum of the maximum state and federal income tax rates at the present time.

In step 1002, a second tax rate is determined comprising the maximum effective tax rate applicable to a recipient of funds from the plurality of sources at a predetermined future time. In some embodiments, the predetermined future time may be a time after retirement, such as the first year of retirement. In other embodiments, the future time may be the time after retirement at which it is anticipated that the recipient will be taxed at the highest rate.

The second tax rate may be determined in a similar manner as the first tax rate. In particular, the second tax rate may be determined by selecting a maximum state income tax rate with a first income floor and a first income ceiling that is applicable to the recipient at the future time; selecting a maximum federal income tax rate with a second income floor less than the first income ceiling and a second income ceiling greater than the first income floor that is applicable to the recipient at the future time; and determining the maximum effective tax applicable to the recipient r at the future time based at least partially on both the maximum state income tax and the maximum federal income tax rate. In many embodiments, the second tax rate is the sum of maximum state and federal income taxes at the future time.

In step 1004, a first retirement account with an associated first tax obligation is selected. In step 1006, a second retirement account with an associated second tax obligation is selected, wherein the second tax obligation is less than the first tax obligation. For example, the first account may be a retirement account such as a 401(k) or similar tax-deferred account with a tax obligation equal to the applicable effective tax rate. The second account may be a retirement account with a tax obligation of zero, such as a Roth IRA.

Once the first and second tax rates are computed and the first and second accounts are selected, in step 1008, the two tax rates are compared. If the first tax rate is greater than the second tax rate, then in step 1010, the funds are invested in the first account (which as noted above may be a 401(k) or other tax-deferred account). If the second tax rate is greater than the first tax rate, then in step 1012, the funds are invested in the second account (which as noted above may be a Roth IRA). Using such a method, tax liability is minimized. In some embodiments comprising instructions on storage media, instead of investing funds, the instructions may be executed by a processor to determine how to invest funds and output the result of the determination to the investor.

This description is illustrative and directed to the methods, instructions on storage media and computing devices described, and may describe multiple embodiments. The claims that are appended to this description, whether now or later in this or a subsequent application, define specific embodiments included in the described methods, storage media and/or computing devices. No single feature or element, or combination thereof, is essential to all possible combinations that may now or later be claimed.

While examples of methods, storage media and computing devices are particularly shown and described, many variations may be made therein. Such variations may be directed to the same combinations and/or to different combinations, and may be different, broader, narrower or equal in scope. An appreciation of the availability, scope or significance of various embodiments may not be presently realized. Thus, any given embodiment disclosed by example in this disclosure does not necessarily encompass all or any particular features, characteristics or combinations, except as specifically claimed. The present disclosure furthermore encompasses instructions contained on storage media which cause a computing device to assist and/or advise a user in performing disclosed methods.

Where “a” or “a first” element or the equivalent thereof is recited, such usage includes one or more such elements, neither requiring nor excluding two or more such elements. Further, ordinal indicators, such as first, second or third, for identified elements are used to distinguish between the elements, and do not indicate a required or limited number of such elements, and do not indicate a particular position or order of such elements unless otherwise specifically indicated.

What is claimed is:

1. A method of distributing funds from a plurality of sources, each source having an associated tax obligation, the method comprising:
selecting a first state income tax rate with a first income floor and a first income ceiling;
selecting a first federal income tax rate with a second income floor less than the first income ceiling and a second income ceiling greater than the first income floor;
determining a first effective tax rate based at least partially on both the first state income tax rate and the first federal income tax rate;
selecting from the plurality of sources a first source with an associated first tax obligation that is greater than a second tax obligation associated with a second source;
distributing funds from the selected first source at the lesser of the first effective tax rate and the first tax obligation until a first distribution-terminating event occurs; and
thereafter distributing funds from the second source at the lesser of a second effective tax rate and the second obligation.

2. The method of claim 1, wherein the first tax obligation is greater than every other tax obligation associated with every other source of the plurality of sources.

3. The method of claim 1, wherein the first distribution-terminating event includes one or more of the lesser of the first income ceiling and the second income ceiling being reached, and the funds in the selected first source being depleted.

4. The method of claim 1 further comprising the step of, prior to distributing funds from the second source, determining the second effective tax rate based on either a combination of the first state income tax rate and a second federal income tax rate having a third income floor less than the first income ceiling, or a combination of a second state income tax rate having a fourth income floor less than the second income ceiling and the first federal income tax rate.

5. The method of claim 4, wherein the step of distributing funds from the second source further includes distributing funds from the second source until a second distribution-terminating event occurs.

6. The method of claim 5, wherein the second distribution-terminating event includes one or more of the lesser of the first income ceiling and a third income ceiling associated with the second federal income tax rate being reached, the lesser of the second income ceiling and a fourth income ceiling associated with the second state income tax rate being reached, and the funds in the second source being depleted.

7. The method of claim 1, further comprising:
selecting from the plurality of sources a third source with an associated third tax obligation that is less than the second tax obligation after distributing funds from the second source; and
distributing funds from the selected third source at the lesser of a third effective tax rate and the third tax obligation.

8. The method of claim 7, wherein the third effective tax rate is greater than the second effective tax rate.

9. The method of claim 1, wherein the step of distributing funds from the second source includes distributing funds from the second source until a predetermined income limit is reached.

10. The method of claim 1, wherein the first effective tax rate comprises a sum of the first state income tax rate and the first federal income tax rate.

11. The method of claim 1, wherein the first tax obligation is equal to the first effective tax rate.

12. The method of claim 11, wherein the first source is a fully taxable retirement account selected from the group consisting of a 401(k), a 403(b), a 457(b), a 457(f) or a Traditional Individual Retirement Account.

13. The method of claim 1, wherein the second tax obligation is less than the second effective tax rate.

14. The method of claim 13, wherein the second source comprises capital gains and the second tax obligation is a capital gains tax.

15. The method of claim 7, wherein the third tax obligation is less than the third effective tax rate.

16. The method of claim 15, wherein the third tax obligation is zero percent.

17. The method of claim 16, wherein the third source comprises a Roth Individual Retirement Account.

18. The method of claim 1, wherein the funds are distributed to an individual, and wherein the plurality of sources collectively correspond to the individual's retirement portfolio.

19. A method of investing funds saved by an investor into a plurality of accounts, the method comprising:
determining a first tax rate comprising a maximum effective tax rate applicable to the investor at a present time;
determining a second tax rate comprising a maximum effective tax rate applicable to a recipient of funds from the plurality of accounts at a predetermined future time;
selecting from the plurality of accounts a first account with an associated first tax obligation;
selecting from the plurality of accounts a second account with an associated second tax obligation that is less than the first tax obligation; and
investing the funds into either the first account when the first tax rate is greater than the second tax rate and the second account when the second tax rate is greater than the first tax rate.

20. The method of claim 19, wherein the plurality of accounts includes at least one retirement account, and the future time is after retirement.

21. The method of claim 19, wherein determining the first tax rate further comprises:
selecting a maximum state income tax rate with a first income floor and a first income ceiling that is applicable to the investor at the present time;
selecting a maximum federal income tax rate with a second income floor less than the first income ceiling and a second income ceiling greater than the first income floor that is applicable to the investor at the present time; and
determining the maximum effective tax rate applicable to the investor at the present time based at least partially on both the maximum state income tax and the maximum federal income tax rate.

22. The method of claim 19, wherein determining the second tax rate further comprises:
selecting a maximum state income tax rate with a first income floor and a first income ceiling that is applicable to the recipient at the future time;
selecting a maximum federal income tax rate with a second income floor less than the first income ceiling and a second income ceiling greater than the first income floor that is applicable to the recipient at the future time; and
determining the maximum effective tax applicable to the recipient at the future time based at least partially on both the maximum state income tax and the maximum federal income tax rate.

23. The method of claim 19, wherein the first account is a tax-deferred retirement account selected from the group consisting of a 401(k), a 403(b), a 457(b), a 457(f) or a Traditional Individual Retirement Account.

24. The method of claim 19, wherein the second tax obligation associated with the second account is equal to zero.

25. The method of claim 24, wherein the second account is a Roth Individual Retirement Account.

26. A storage medium, readable by a processor of a computer system, having embodied therein a first computer program of commands executable by the processor, the program being adapted to be executed to:
select from the plurality of sources a first source with an associated first tax obligation that is greater than a second tax obligation associated with a second source;
select a first state income tax rate with a first income floor and a first income ceiling;
select a first federal income tax rate with a second income floor less than the first income ceiling and a second income ceiling greater than the first income floor;
determine a first effective tax rate based at least partially on a sum the first state income tax rate and the first federal income tax rate;
determine a first distribution scheme in which funds are distributed from the selected first source at the lesser of the first effective tax rate and the first tax obligation until a first distribution-terminating event occurs; and
thereafter determine a second distribution scheme in which funds are distributed from the second source at the lesser of a second effective tax rate and the second obligation.

27. The storage medium of claim 26, wherein the first distribution-terminating event includes one or more of the lesser of the first income ceiling and the second income ceiling being reached, and the funds in the selected first source being depleted.

28. The storage medium of claim 26, wherein the first tax obligation is greater than every other tax obligation associated with every other source of the plurality of sources.

29. The storage medium of claim 26, wherein the program is further adapted to be executed to, prior to determining the second distribution scheme, determine the second effective tax rate based on either a combination of the first state income tax rate and a second federal income tax rate having a third income floor less than the first income ceiling, or a combination of a second state income tax rate having a fourth income floor less than the second income ceiling and the first federal income tax rate.

30. The storage medium of claim 29, wherein the program is further adapted to be executed to determine the second distribution scheme so that funds are distributed from the second source until a second distribution-terminating event occurs.

31. The storage medium of claim 30, wherein the second distribution-terminating event-includes one or more of the lesser of the first income ceiling and a third income ceiling associated with the second federal income tax rate being reached, the lesser of the second income ceiling and a fourth income ceiling associated with the second state income tax rate being reached, and the funds in the second source being depleted.

32. The storage medium of claim 31, wherein the program is further adapted to be executed to:
select from the plurality of sources a third source with an associated third tax obligation that is less than the second tax obligation after distributing funds from the second source; and
determine a third distribution scheme in which funds are distributed from the selected third source at the lesser of a third effective tax rate and the third tax obligation, wherein the third effective tax rate is greater than the second effective tax rate.

33. The storage medium of claim 26, wherein the first tax obligation is equal to the first effective tax rate.

34. The storage medium of claim 33, wherein the first source is a fully taxable retirement account selected from the group consisting of a 401(k), a 403(b), a 457(b), a 457(f) or a Traditional Individual Retirement Account.

35. The storage medium of claim 26, wherein the second tax obligation is less than the second effective tax rate.

36. The storage medium of claim 35, wherein the second source comprises capital gains and the second tax obligation is a capital gains tax.

37. A storage medium, readable by a processor of a computer system, having embodied therein a first computer program of commands executable by the processor, the program being adapted to be executed to:
determine a first tax rate comprising a maximum effective tax rate applicable to an investor at a present time;
determine a second tax rate comprising a maximum effective tax rate applicable to a recipient of funds from a plurality of accounts at a predetermined future time;
select from the plurality of accounts a first account with an associated first tax obligation;
select from the plurality of accounts a second account with an associated second tax obligation that is less than the first tax obligation; and
determine a first distribution scheme in which funds are invested by the investor into the first account when the first tax rate is greater than the second tax rate and the second account when the second tax rate is greater than the first tax rate.

38. The storage medium of claim 37, wherein the program is further adapted to be executed to:
select a maximum state income tax rate with a first income floor and a first income ceiling that is applicable to the investor at the present time;
select a maximum federal income tax rate with a second income floor less than the first income ceiling and a second income ceiling greater than the first income floor that is applicable to the investor at the present time; and
determine the maximum effective tax rate applicable to the investor at the present time based at least partially on both the maximum state income tax and the maximum federal income tax rate.

39. The storage medium of claim 37, wherein the program is further adapted to be executed to:
select a maximum state income tax rate with a first income floor and a first income ceiling that is applicable to the recipient at the future time;
select a maximum federal income tax rate with a second income floor less than the first income ceiling and a second income ceiling greater than the first income floor that is applicable to the recipient at the future time; and
determine the maximum effective tax applicable to the recipient at the future time based at least partially on both the maximum state income tax and the maximum federal income tax rate.

40. The method of claim 37, wherein the first account is a tax-deferred retirement account selected from the group consisting of a 401(k), a 403(b), a 457(b), a 457(f) or a Traditional Individual Retirement Account.

41. The method of claim 37, wherein the second account is a Roth Individual Retirement Account.
